(19) United States
(12) Patent Application Publication
(10) Pub. No.: US 2026/0280107 A1
(43) Pub. Date: Sep. 17, 2026

(54) MULTI-ANTENNA MOUNTING ARRANGEMENT

(71) Applicant: Telefonaktiebolaget LM Ericsson (publ), Stockholm (SE)

(72) Inventors: Jan SANDBERG, Frillesås (SE); Jonas GUSTAVSSON, Bredared (SE)

(21) Appl. No.: 19/167,198

(22) PCT Filed: Mar. 23, 2023
(86) PCT No.: PCT/SE2023/050262

§ 371 Date: Sep. 19, 2025

(51) Int. Cl. H01Q 1/34; H01Q 1/12; H01Q 3/02; H01Q 21/28

(52) U.S. Cl. CPC H01Q 1/34; H01Q 1/125; H01Q 3/02; H01Q 21/28

(57) ABSTRACT

The present disclosure refers to a multi-antenna mounting arrangement for configuring the spacing between two spatially separated antenna arrangements. The multi-antenna mounting arrangement includes the two antenna arrangements and a controllable adjustment arrangement to which the antenna arrangements are arranged. Respective antenna arrangement includes an antenna and a radio unit, the radio unit being collocated with, and connected to, the antenna, and the adjustment arrangement enabling controlling the spatial separation (d) between the two antenna arrangements. The present disclosure also refers to a multi-antenna mast arrangement includes an antenna mast and a multi-antenna mounting arrangement.

### TECHNICAL FIELD

The present disclosure is directed to a multi-antenna mounting arrangement facilitating for antenna operation and antenna arrangement maintenance.

### BACKGROUND

MIMO, Multiple-Input Multiple-Output, antenna technology is a well-established antenna technology for enhancing spectral efficiency and reliability of wireless communication using microwave transmissions. In a MIMO antenna system, multiple antenna elements, generally referred to as antennas, are deployed both at the transmitter side and the receiver side. This allows for transmission of multiple data streams on the same transmission frequency simultaneously, in comparison to more conventional single-antenna systems, also referred to as SISO, Single-Input Single-Output, which can only transmit one microwave transmission data stream, on one transmission frequency, at the time. The plurality of antennas, enabling the multiple microwave transmission data streams, leads to an increase in capacity, for example by increasing the spectral efficiency.

Antennas used for wireless communication are generally located at rooftops or other elevated and exposed locations. Current, and most likely also future, wireless communication technologies rely on use of directive antennas. It is essential that directive antennas are mounted with high precision, vertically as well as horizontally. If transmitting and receiving antennas used to provide wireless communication are not placed, directed and configured correctly, connectivity provided by the antennas can be adversely affected. For multi-antenna arrangements, such as MIMO antenna systems, accurate and precise installation is even more important since not only the exact direction of the transmitting and receiving antennas needs to be considered, but at reception also interference between neighbouring antennas needs to be considered and compensated for. The antennas should for example be arranged with the correct vertical and horizontal spatial separation. That antennas used for wireless communication generally are mounted on elevated locations also entails that they may be exposed to high wind loads. This is even more evident for multi-antenna arrangements such as MIMO antenna systems due to the higher number of individual antennas, leading to a larger exposed antenna surface, and that the antennas generally are arranged further apart. That the antennas are arranged far apart from one another is sometimes also problematic when performing maintenance work.

The high accuracy required for MIMO antenna systems is not only relevant when deploying the antennas. It also applies when, or after, performing maintenance work or when replacing malfunctioning components of the antenna system. When a MIMO antenna system is deployed, or after maintenance work is performed, several re-alignments and tunings of the antenna installation is often needed.

### SUMMARY

As discussed, antenna installations used for wireless communication are generally placed at exposed locations. For multi-antenna installations the distance between individual antennas may be several meters. This means that installation as well as maintenance work generally is challenging, and that service technicians must manage sometimes difficult working conditions. Also, the complexity of the components of multi-antenna systems are increasing with every generation of wireless communication technology. This is even more evident if the multi-antenna installation not only comprises antenna components but also components related to the radio unit.

It is an object of the present disclosure to provide an improved multi-antenna mounting arrangement facilitating maintenance work of antennas, or maybe more relevant, collocated radio units. Multi-antenna mounting arrangements according to the disclosure also facilitates improved multi-antenna operation. It is yet an object of the disclosure to provide antenna mast arrangements comprising such multi-antenna arrangements also benefitting from the advantages provided by multi-antenna mounting arrangements according to the present disclosure.

This object is at least partly obtained by a multi-antenna mounting arrangement for configuring the spacing between two spatially separated antenna arrangements. The multi-antenna mounting arrangement comprises the two antenna arrangements and a controllable adjustment arrangement to which the antenna arrangements are arranged. Respective antenna arrangement comprises an antenna and a radio unit, the radio unit being collocated with, and connected to, respective the antenna, and the adjustment arrangement enabling controlling the spatial separation d between the two antenna arrangements.

The present disclosure presents a number of advantages. One exemplary advantage being that since the disclosure enables the antenna arrangements, comprising the antennas and radio units, to be positioned close together when installing the antenna arrangements, when re-aligning the antenna arrangements or when performing maintenance work, this work is significantly simplified and can be performed faster and in a safer manner since the work can be performed close to the center of the mast. Additional exemplary advantages will be present in connection to embodiments of the disclosure presented below.

According to embodiments, the antenna arrangements are spatially separated horizontally or vertically.

According to embodiments, the adjustment arrangement is configured such that when using the adjustment arrangement to change the spatial separation d between the two antenna arrangements, respective antenna arrangement is moved an equal distance Δd/2 in respect to a reference point on an axis extending between the antenna arrangements. An additional exemplary advantage is thus that alignment can be done for both antenna arrangements at the same time. For further clarification, the adjustment arrangement is configured such that when using the adjustment arrangement to change the spatial separation d between the two antenna arrangements, both antenna arrangements are moved an equal distance Δd/2, but in opposite directions. Either they are moved closer together or further apart from each other.

According to embodiments, the adjustment arrangement is provided with a position marking arrangement, the position marking arrangement indicating a position of at least one antenna arrangement. According to further embodiments, the position marking arrangement indicates a service position (herein generally referred to as position B) and an operation position (herein generally referred to as position A) of at least one antenna arrangement. An advantage of using a marking arrangement as of embodiments of the present disclosure is that it is possible for a service technician, having climbed a mast to perform maintenance work on the multi-antenna mounting arrangement, to know the exact position of the antenna arrangements before the antenna arrangements are moved to a position where service work can be performed. This enables the service technician to, once maintenance work is performed, position the antenna arrangements of the multi-antenna mounting arrangement back to the operation position. According to other embodiments, the position marking arrangement indicates a second operation position (herein generally referred to as position C) of one antenna arrangement, wherein the second operation position (position C) is determined by applied precoding. An advantage of being able to change precoding, and as a result thereof be able to have the antenna arrangements positioned closer to one another also during operation, is that the forces the multi-antenna mounting arrangement is exposed to at heavy wind are reduced.

According to embodiments, the adjustment arrangement comprises two, interconnected and in respect to each other moveable elements, wherein the antenna arrangements are arranged to one element each. According to embodiments, the adjustment arrangement comprises: a slidebar carrier and a slidebar, the slidebar carrier being arranged to receive the slidebar such that the slidebar can move within the slidebar carrier, and wherein one antenna arrangement is arranged to the slidebar, and one antenna arrangement is arranged to the slidebar carrier. According to other embodiments, the adjustment arrangement comprises: two racks and a pinion, the two racks being arranged in parallel, and the pinion being arranged to separate the racks and to engage with the racks so that upon revolving of the pinion the racks move in opposite directions, and wherein one antenna arrangement is arranged to each of the racks. According to embodiments, the revolving of the pinion is controlled by means of turning a crank handle. According to other embodiments, the adjustment arrangement comprises a motor arranged to control the operation of the adjustment arrangement, with other words, the movement of the elements of the adjustment arrangement. Non-limiting examples of how elements of the adjustment arrangement may be controlled by means of a motor is provided below. The motor may be an electrical motor. According to embodiments, the motor may be arranged to control the revolving of the pinion or to control the displacement of the slidebar within the slidebar carrier.

According to embodiments, the motor is configured to, upon a first trigger, control the adjustment arrangement so that at least one antenna arrangement is moved, or displaced, to a service position (herein generally referred to as position B), and upon a second trigger, control the adjustment arrangement so that the at least one antenna arrangement is returned to the position (herein generally referred to as position A) it had before the first trigger occurred. It should be noted that herein embodiments of the disclosure when two antenna arrangements are moved are generally referred to. According to embodiments, both antenna arrangements are returned to the position it had before the first trigger occurred. According to other embodiments, the motor is configured to, upon a third trigger, control the adjustment arrangement so that at least one antenna arrangement is moved, or displaced, to a second operation position (herein generally referred to as position C), wherein the second operation condition (position C) is determined by applied precoding. According to embodiments, both antenna arrangements are moved, or displaced, to the second operation position.

Another aspect of the present disclosure refers to a multi-antenna mast arrangement comprising an antenna mast and a multi-antenna mounting arrangement, the multi-antenna mounting arrangement comprising two antenna arrangements and a controllable adjustment arrangement to which the antenna arrangements are arranged. Respective antenna arrangement comprises an antenna and a radio unit, the radio unit being collocated with, and connected to, respective antenna, and the adjustment arrangement enabling controlling the spatial separation d between the two antenna arrangements. The multi-antenna mounting arrangement may be any embodiment of a multi-antenna mounting arrangement disclosed herein, wherein the multi-antenna mast arrangement will benefit from any advantages provided by such multi-antenna mounting arrangement.

Further advantages of embodiments of the present disclosure are discussed below.

### BRIEF DESCRIPTION OF THE DRAWINGS

FIG. 1A-B schematically illustrates a first embodiment of the disclosure,

FIG. 2A-C schematically illustrates a second embodiment of the disclosure,

FIG. 3 schematically illustrates a first exemplary embodiment of an adjustment arrangement according to the disclosure,

FIG. 4 schematically illustrates a second exemplary embodiment of an adjustment arrangement according to the disclosure, and

FIG. 5 schematically illustrates the physics of an exemplary multi-antenna system.

### DETAIL DESCRIPTION

Aspects of the present disclosure will now be described more fully with reference to the accompanying drawings. The different arrangements, devices, systems etc. disclosed herein may however be realized in various ways and should not be construed as being limited to the exemplary embodiments disclosed and discussed herein. Generally, the various reference numbers used in the drawings refer to different elements, whereas the same reference number indexed with different letters indicates different individuals of the same element.

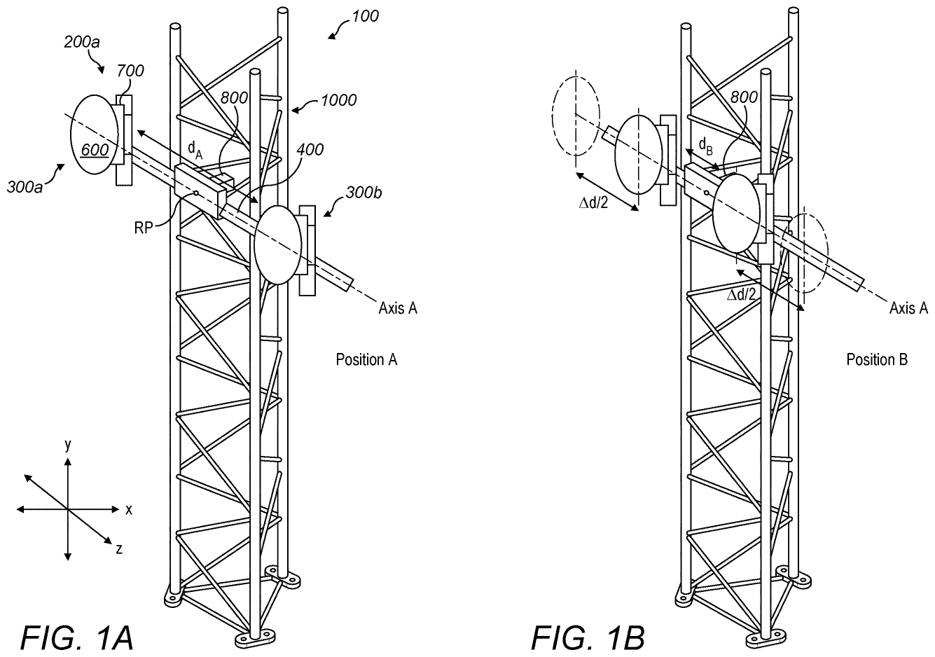

FIG. 1A and FIG. 1B schematically illustrates a first embodiment of the disclosure, more precisely a multi-antenna mast arrangement 100 comprising an antenna mast 1000 and a multi-antenna mounting arrangement 200a. The multi-antenna mounting arrangement 200a is provided for configuring the spacing between two spatially separated antenna arrangements 300a, 300b (herein also referenced to as 300). The multi-antenna mounting arrangement 200a comprises the two antenna arrangements 300a, 300b and a controllable adjustment arrangement 400. The antenna arrangements 300a, 300b are arranged to the controllable adjustment arrangement 400. Respective antenna arrangement 300a, 300b comprises at least one antenna 600 and at least one radio unit 700, wherein the radio unit 700 is collocated with, and connected to, respective antenna 600. The adjustment arrangement 400 is configured to enable controlling of the spatial separation d (d_{A}, d_{B}) between the two antenna arrangements 300a, 300b. Various embodiments of how adjustment arrangements may be configured is discussed more in detail below. According to embodiments, each antenna 600 is collocated with, and connected to, one radio unit 700 per antenna 600.

In the exemplary embodiment of FIG. 1A and FIG. 1B, and as discussed above, the antenna arrangements 300a, 300b of the multi-antenna mounting arrangement 200a, are spatially separated horizontally, but according to other embodiments, two antenna arrangements may also be arranged vertically, meaning one antenna arrangement over the other, whereby the adjustment arrangement is provided to control the vertical spatial separation between the two antenna arrangements. Obviously, the arrangement orientation of the transmitting antennas and the receiving antennas should correspond, meaning that if transmitting antennas are arranged with vertical separation, also the receiving antennas should be arranged with a vertical separation. Preferably, the spatial separation between transmitting and receiving antennas should be essentially the same. Generally, the bigger the difference in spatial separation between transmitting antennas and receiving antennas is, the more robust modulation is required.

According to embodiments, respective antenna arrangement may be provided with one or more radio units, for example one radio unit for vertical and one for horizonal polarization, and one or more antenna (element(s)), for example one antenna element for vertical and one for horizontal polarization.

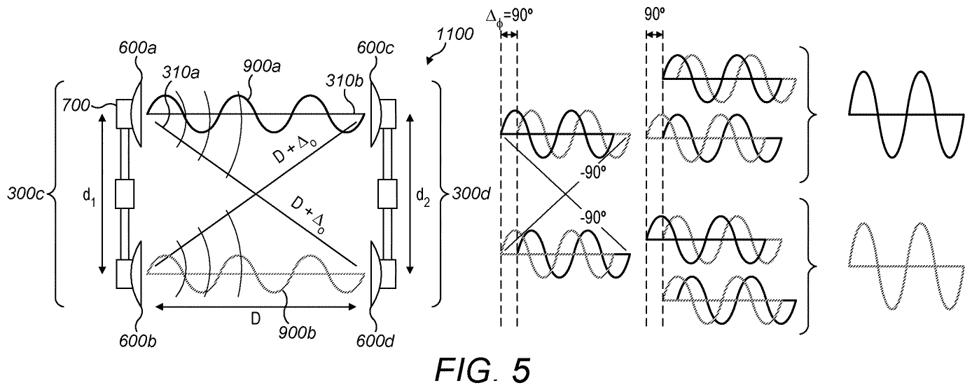

FIG. 1A and FIG. 1B shows the exemplary multi-antenna mounting arrangement 200 in two positions referred to as position A, shown in FIG. 1A, and position B, shown in FIG. 1B. Position A may represent an operational position, or operation position, and position B may represent a service position. The operation position (position A) may be the position the antenna arrangements 300a, 300b are in when being in operation. The configuration of the operation position (position A), or the spatial separation d_{A} between the antenna arrangements 300a, 300b when being in the operation position (position A), is for example determined by the distance to receiving multi-antenna arrangement (given that the multi-antenna arrangement currently discussed is a transmitting antenna arrangement) and transmission frequency f (or wavelength λ). Distance between transmitting and receiving antennas (or antenna arrangements) are herein generally referred to as direct path length or hop length. Hop length between transmitting and receiving antenna arrangements, and spatial separation between antenna elements of a multi-antenna system, is discussed more in detail in relation to FIG. 5.

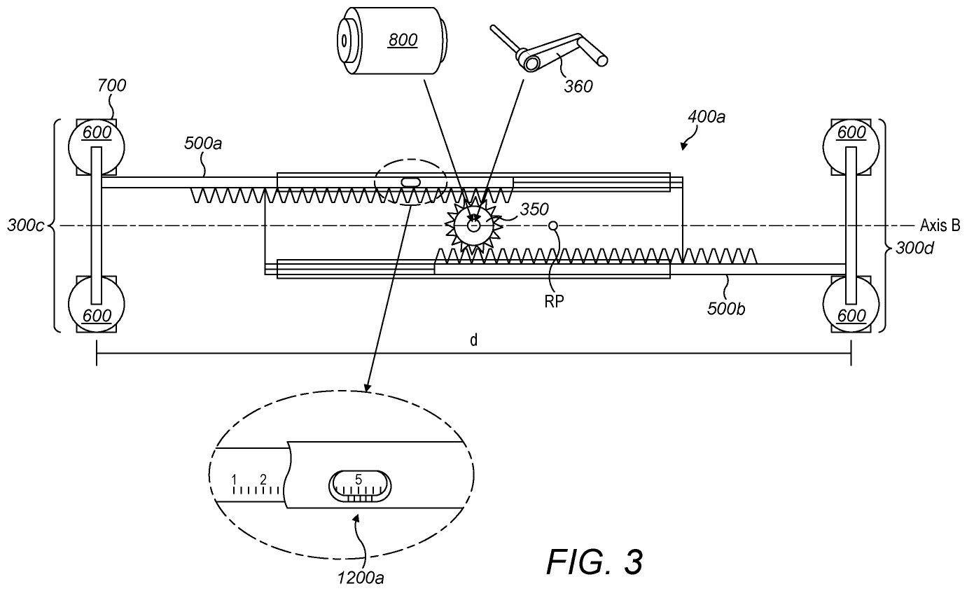

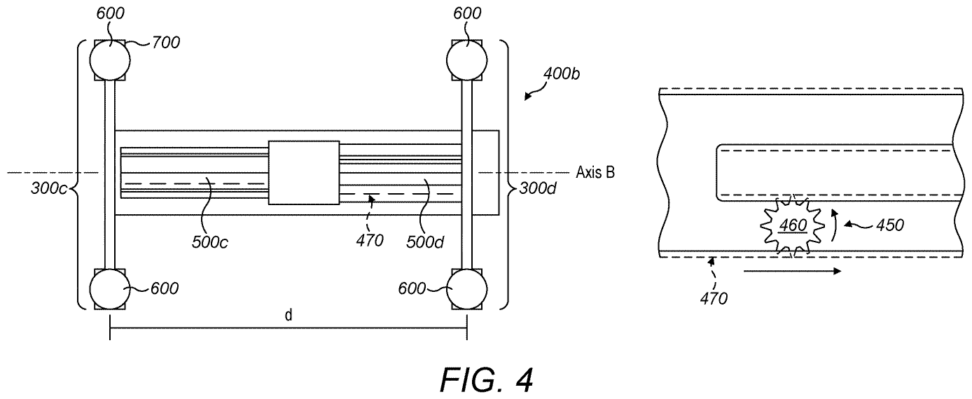

FIG. 1B shows that when being in the service position (position B), the spatial separation between the antenna arrangements 300a, 300b d_{B} is much smaller compared to the spatial separation d_{A} when being the operation position (position A). The difference in spatial separation, hence the difference in distance between d_{A} and d_{B} is herein denoted Δd, hence Δd=d_{A}−d_{B}. By reducing the spatial separation between the antenna arrangements maintenance work is facilitated. Even though not visible in FIG. 1A and FIG. 1B, operation position A and service position B may be marked by means of a position marking arrangement, marking the position of at least one of the antenna arrangements. As will be discussed more in detail below, when implementing embodiments of multi-antenna mounting arrangements of the disclosure, if the position of one antenna arrangement is known, inherently the position of a second antenna arrangement is also known. This is discussed more in detail in relation to FIG. 3 and FIG. 4.

When being in position B (service position), the antenna arrangements 300a, 300b are positioned much closer to one another and can both easily be accessed by service technicians performing maintenance work without having to climb out to respective antenna arrangement 300a, 300b. This is to be compared to the accessibility of for example the radio units 700 when the antenna arrangements 300a, 300b are in position A (operation position). Being able to move the antenna arrangements 300a, 300b to the service position facilitates maintenance work, saves time and makes the work much safer.

According to embodiments, the adjustment arrangement 400, is configured such that when using the adjustment arrangement 400 to change the spatial separation, d, between the two antenna arrangements 300a, 300b, respective antenna arrangement 300a, 300b is moved an equal distance, Δd/2, in respect to a reference point on an axis Axis A extending between the antenna arrangements 300a, 300b. (The reference point can be located anywhere on the Axis A as long as it is located between, and through, the antenna arrangements 300a, 300b.) For further clarification, according to embodiments, the adjustment arrangement is configured such that when using the adjustment arrangement to change the spatial separation d between the two antenna arrangements, both antenna arrangement are moved an equal distance Δd/2 but in opposite directions. As will be discussed more in detail below, the spatial separation, d, hence also a change of the spatial separation, Δd, is one of the variables that has to be known, or that you have to be able to calculate, when designing and deploying a multi-antenna system. This information is for example necessary when determining a precoding to be applied.

In the exemplary embodiment shown in FIG. 1A and FIG. 1B the antenna arrangements 300a, 300b are placed side by side in a horizontal direction. An advantage of the exemplary embodiment of the disclosure shown in FIG. 1A and FIG. 1B is that when the antenna arrangements 300a, 300b are moved, by means of the adjustment means 400, they will be moved an equal distance in respect to the center of gravity of the multi-antenna mounting arrangement 200a. This in turn has the effect that the multi-antenna mounting arrangement 200a, the multi-antenna mast arrangement 100 and the antenna mast 1000, will not be exposed to any additional forces due to altered, or uneven, weight distribution when moving the antenna arrangements 300a, 300b, which would have been the case if only one of the antenna arrangements 300a, 300b was moved when changing the spatial separation.

As previously mentioned, although not shown in FIG. 1A and FIG. 1B, according to embodiments of the disclosure, the antennas may also be vertically arranged, meaning one antenna arrangement over the other.

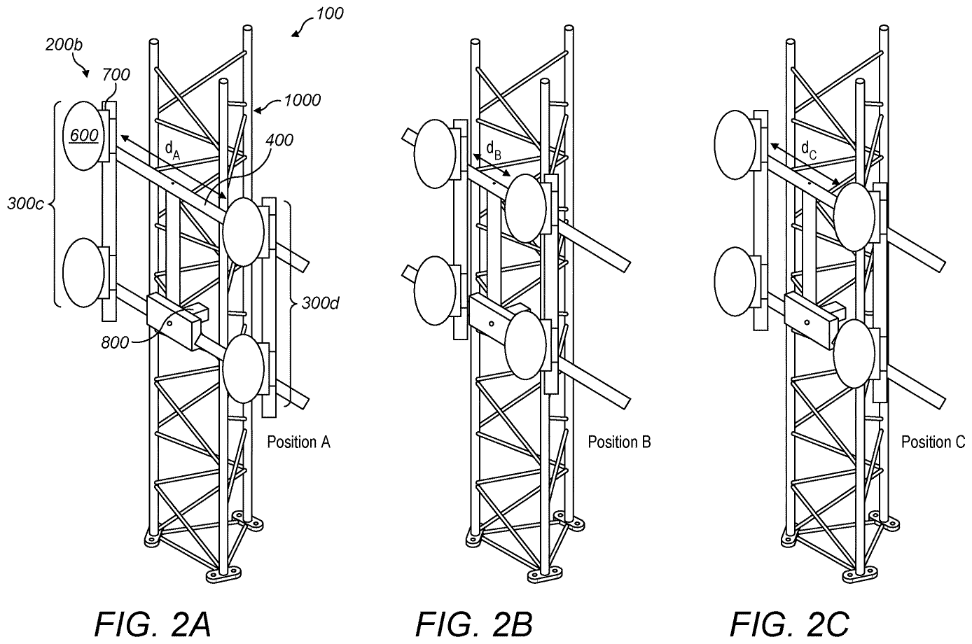

FIG. 2A, FIG. 2B and FIG. 2C schematically illustrates a second embodiment of the disclosure in which the multi-antenna mounting arrangement 200b comprises two antenna arrangements 300c, 300d (herein also referenced to as 300), but where each antenna arrangement 300c, 300d comprises two antennas 600 with one radio unit 700 each. The embodiment shown in FIG. 2A, FIG. 2B and FIG. 2C shows that respective antenna arrangement 300c, 300d comprises radio unit 700 per antenna 600, but according to embodiments one radio unit may be provided per (vertical or horizontal) pair of antennas. An advantage of this is obviously that less radio units are needed. The radio unit is the most frequent source for malfunctioning of antenna arrangements with collocated antenna and radio unit.

The embodiment of a multi-antenna mounting arrangement 200 shown in FIG. 2A, FIG. 2B and FIG. 2C further schematically illustrates that the adjustment arrangement 400 comprises a motor 800, arranged to control the operation of the adjustment arrangement 400. According to embodiments, the motor 800 may be an electrical motor.

FIG. 2A, FIG. 2B and FIG. 2C shows the exemplary multi-antenna mounting arrangement 200b in three positions referred to as position A, shown in FIG. 2A, position B, shown in FIG. 2B, and position C, shown in FIG. 2C. As discussed in relation to FIG. 1A and FIG. 1B, position A of FIG. 2A may represent an operation position and position B of FIG. 2B may represent a service position. Position C of FIG. 2C may represent a second operation position in which the horizontal spatial separation d_{C} is configured to be between position A and position B. As discussed, antenna arrangements in general, and multi-antenna arrangements in particular, may be exposed to significant wind loads. The larger the spatial separation between the antenna arrangements of a multi-antenna arrangement is, the more severe are the forces the multi-antenna is exposed to due to the lever effect. Embodiments of the disclosure enables multi-antenna arrangements of the disclosure to have not only one (first) operation position (position A) but also at least a second operation position (position C) which can be used during for example heavy wind. With knowledge acquired by studying the present disclosure, the skilled person will understand that also additional operation positions may be defined. Changing the operation position from position A to position C, which will decrease the horizontal separation from d_{A} to d_{C}, will, at least to some extent, lower the wind load the multi-antenna mounting arrangement 200b is exposed to. However, reducing the horizonal spatial separation of the antenna arrangements 300c, 300d has to be compensated for by applying a (different) precoding. According to embodiments, the spatial separation d_{C} may be about 60% of d_{A}.

According to further embodiments of the disclosure, the motor 800 of the adjustment arrangement 400 may be configured to, upon a first trigger, control the adjustment arrangement 400 so that the antenna arrangements 300c, 300d are moved, or displaced, to the service position (position B), and upon a second trigger, control the adjustment arrangement 400 so that the antenna arrangements 300c, 300d are returned to the position (operation position, position A) it had before the first trigger occurred. According to yet further embodiments, the motor 800 of the adjustment arrangement 400 may configured to, upon a third trigger, control the adjustment arrangement 400 so that the antenna arrangements 300c, 300d are moved, or displaced, to the second operation (position C), wherein the second operation (position C) is determined by applied precoding.

The triggers, thus what herein generally is referred to as the first, second and third trigger, could for example be that a service technician indicates by means of a for example a remote control or a control panel that the motor of the adjustment arrangement should move the antenna arrangements to any of position A, position B or position C.

A number of non-limiting examples triggers that automatically may cause the antenna arrangements of a multi-antenna mounting arrangement according to the present disclosure to move to a defined position are now discussed:

A trigger for moving the antenna arrangements to position B, the service position, could for example be that a radio unit of an antenna arrangement is turned off. A trigger for moving the antenna arrangements back to position A, operation position, could for example be that the radio unit has been turned back on for a period of time.

A trigger for moving the antenna arrangements to position C, the second operation position, could for example be that an anemometer, preferably arranged in connection to the multi-antenna mounting arrangement, indicates that a preset wind speed (wind load) threshold is reached. As mentioned, operating the multi-antenna mounting arrangement when being in position C may generally requires that a (different) precoding is applied.

A trigger for moving the antenna arrangement to position B, the service position, could for example be malfunctioning of one of the components of one of the antenna arrangements, such as for example malfunctioning of one radio units. When one of the antenna arrangements are not working properly, what also may be referred to as failure mode, the multi-antenna mounting arrangement may still operate as a SISO antenna.

According to embodiments of the disclosure, one alternative to controlling the adjustment arrangement, thus the spatial separation between the antenna arrangements, with a motor is to control the adjustment arrangement by means of a crank handle. This will be discussed more in detail in relation to FIG. 3.

Still referring to FIG. 2A, FIG. 2B and FIG. 2C; the embodiment of a multi-antenna mounting arrangement 200b shown in FIG. 2A, FIG. 2B and FIG. 2C is configured to adjust and control the horizontal spatial separation of antenna arrangements 300c, 300d. It should however be noted that other embodiments of multi-antenna mounting arrangements according to the disclosure may be configured to adjust and control the vertical spatial separation of antenna arrangements.

According to yet further embodiments (not shown in FIG. 2A, FIG. 2b or FIG. 2C), for a multi-antenna mounting arrangement comprising four antenna arrangements, wherein each antenna arrangement comprises at least one antenna with a collocated and thereto connected radio unit, the multi-antenna mounting arrangement comprises two adjustment arrangements, wherein one adjustment arrangement is configured (or arranged) to control vertical separation of the antenna arrangements and one adjustment arrangement is configured (or arranged) to control horizontal separation of the antenna arrangements.

It should be noted that the present disclosure is not limited to multi-antenna mounting arrangements comprising two or four antenna arrangements. Aspects of the present disclosure are also applicable for multi-antenna systems comprising for example six or eight antenna arrangements.

As will be recognized by the skilled person, when herein referring to radio unit, this may either be a radio unit of what sometimes is referred to as an “all outdoor” system, meaning a radio unit configured to manage (hence comprising apparatuses capable of managing) for example frequency conversion, power regulation, traffic handling and signal processing, or it may be a radio unit of what sometimes is referred to as “split-mount” system, meaning that for example traffic handling, signal processing and power regulation are managed by an indoor (radio) unit, connected to the outdoor (radio) unit by a coax cable or via optical fiber. The outdoor (radio) unit may for example be responsible for frequency conversion. In some embodiments, the indoor unit may be comprised in, or may be collocated with, what generally also may be referred to as modem unit or baseband unit. Generally, modem units are arranged indoors and are defined as being responsible for baseband signal processing, thus being responsible for managing the signal to be transmitted (or that has been received) prior to modulation. The skilled person will recognize that what functionalities that are provided in the radio unit and in the modem unit may vary and is to some extent a question of definition. This set-up is sometimes also described as that the antenna arrangement (in addition to the transmitting and receiving antennas) comprises a remote radio head, collocated with the antennas, and a modem unit.

One of the most delicate aspects of an antenna installation is the transfer of microwaves generated by the radio unit to the transmitting antenna or transfer of microwaves received by a receiving antenna. For some installations, flexible waveguides can be used (instead of rigid waveguides), but the improved flexibility of using flexible waveguides comes at a cost of higher, unwanted attenuation. The present disclosure addresses this problem by offering a sustainable solution for arranging antenna and radio unit together, herein generally referred to as collocated antenna and radio unit, which will facilitate installation. Arranging radio unit and antenna together is to some extent enabled by recent development of smaller and lighter radio units and components thereof.

The skilled person will be familiar with that respective arrangement has its advantages and drawbacks. The skilled person will also be familiar with that the above general disclosure of radio unit is not exhaustive and should in no way be limiting for the present disclosure. The skilled person will recognize that what herein is referred to as radio unit (or remote radio head) may also comprise additional apparatuses, and manage additional operations and functionalities, than the exemplary ones explicitly mentioned above. Also, what functionalities, or what is managed, by an indoor (radio) unit and an outdoor (radio) unit may vary between different implementations and needs.

FIG. 3 and FIG. 4 schematically illustrate two exemplary embodiments of how an adjustment arrangement 400a, 400b of multi-antenna mounting arrangements according to the present disclosure may be configured. Respective adjustment arrangement 400a, 400b comprises (at least) two, interconnected and in respect to each other moveable elements 500a, 500b wherein the antenna arrangements 300c, 300d are arranged to one moveable element 500a, 500b each. The antenna arrangements 300c, 300d of FIGS. 3 and 4 comprise two antennas 600, with one radio unit 700, each, hence, FIGS. 3 and 4 disclose a (transmitting or receiving) multi-antenna mounting arrangement of a 4×4 MIMO antenna systems. (4×4 indicating that the transmitting multi-antenna mounting arrangement as well as the receiving multi-antenna mounting arrangement comprises four antennas.)

The skilled person will recognize that the exemplary embodiments of how to implement an adjustment arrangement 400a, 400b shown in FIGS. 3 and 4 are just exemplary embodiments and that also other embodiments are feasible.

Referring now to FIG. 3, disclosing a first exemplary embodiment of an adjustment arrangement 400a according to the disclosure. According to the first exemplary embodiment, the adjustment arrangement 400a comprises moveable elements in form of two racks 500a, 500b and a pinion 350, the two racks 500a, 500b being arranged in parallel, and the pinion 350 being arranged to separate the racks 500a, 500b and to engage with the racks 500a, 500b (or connect to the racks) so that upon revolving of the pinion 350 the racks 500a, 500b move in opposite directions. When moving in opposite directions, the racks 500a, 500b move in parallel to an axis Axis B, the Axis B extending between (and through) the antenna arrangements 300c, 300d, and in parallel to each other. In FIG. 3, one antenna arrangement 300c, 300d is arranged to each of the racks 500a, 500b. Consequently, the adjustment arrangement 400a is configured such that when the adjustment arrangement 400a is used to change the spatial separation d between the two antenna arrangements 300c, 300d, respective antenna arrangement 300c, 300d is moved an equal distance Δd/2 in respect to a reference point on the axis Axis B extending between the antenna arrangements 300c, 300d.

Antenna arrangement 300c is arranged to rack 500a and antenna arrangement 300d is arranged to rack 500b. For clarification, the racks 500a, 500b are examples of what herein also is referred to as (moveable) elements of an adjustment arrangement for the exemplary embodiment shown in FIG. 3.

For further clarification: As is visualized in FIG. 3, both the pinion 350 and the racks 500a, 500b are provided with cogs or teeth. The cogs of the pinion 350 are configured to engage with the cogs of respective rack 500a, 500b. Upon revolving of the pinion 350, the cogs of the pinion 350 interact with the cogs of respective rack 500a, 500b, causing the racks 500a, 500b to move in opposite directions along the same axis, Axis B.

According to embodiments of the disclosure, revolving of the pinion 350 is controlled by means of turning a crank handle 360. The crank handle 360 is preferably arranged so that it can easily be accessed by a service technician having climbed the mast to the multi-antenna mounting arrangement. According to other embodiments, the adjustment arrangement 400a comprises a motor 800 arranged to control the operation of the adjustment arrangement 400a by controlling the revolving of the pinion 350. According to embodiments, the motor 800 may be controllable by means of remote control or via a control panel, or similar, arranged so that it easily can be accessed by the service technician.

According to yet one embodiment of the disclosure, the adjustment arrangement 400a is provided with a position marking arrangement 1200a, the position marking arrangement 1200a indicating a position of at least one antenna arrangement 300c, 300d. According to embodiments, the position marking arrangement 1200a may be in form of position marks, simply marking the position the antenna arrangements 300c, 300d should be in when being aligned for operation (i.e. position A in FIG. 1A and FIG. 2A or position C of FIG. 2C) or when being in a service position (position B in FIG. 1B or 2B), or in form of a scale. Since the antenna arrangements 300c, 300d, each arranged to one of the racks 500a, 500b, move uniformly, but in different directions, in relation to the pinion 350, if the position, or change of position, of one antenna arrangement 300c, 300d is known, also the position of the other antenna arrangement 300d, 300c is known. The position marking arrangement 1200a provides the advantage that it provides information about the spatial separation between the antenna arrangements 300c, 300d, which can help service technicians to set correct spatial separation between the antenna arrangements 300c, 300d. The spatial separation between the antenna arrangements 300c, 300d, or change of spatial separation, is important to know since it needs to be configured in respect to for example the hop length. The spatial separation is also important information when applying precoding.

The physics and math behind MIMO antenna systems will be discussed more in detail in connection to FIG. 5.

The position marking arrangement 1200a provides the advantage that at maintenance work, or when replacing malfunctioning components of one or more of the antenna arrangements 300c, 300d, a service technician can keep track of the position of the antenna arrangements 300c, 300d.

For further clarification: 1) Before service, the antenna arrangements are generally configured to be at a position where high performance, wireless communication using microwave transmissions is provided by the multi-antenna mounting arrangement comprising the antenna arrangements (the antenna arrangements may for example be positioned at an operation position, position A). The current position of the antenna arrangements is shown by the position marking arrangement, for example by a mark or by means of a scale. 2) By means of the adjustment arrangement, the antenna arrangements can be moved to a position where service or replacement work easily and safely can be performed by a service technician (for example when being positioned at a service position, position B). A suitable service position, position B, may also be indicated by means of the position marking arrangement. Finally, 3) after maintenance work/replacement work is completed, the antenna arrangements can be returned to the position, the position once again being shown by the position marking arrangement, the antenna arrangements had before service/replacement work was initiated (for example back to operation position, position A).

The skilled person will appreciate that the position marking arrangement may indicate the position of at least one antenna arrangement in various ways, such as for example by using the metric system or the imperial system. According to embodiments, the position marking arrangement may alternatively or additionally indicate the hop length where a specific spatial separation is suitable.

According to further embodiments, as mentioned, the position marking arrangement 400a may at least indicates a second operation position of (at least) one antenna arrangement 300c, 300d, wherein the second operation position is determined by to be applied, or in respect to to be used, precoding. According to embodiments, the precoding may enable the antenna arrangements to be positioned with less spatial separation. Less spatial separation may, at least to some extent, lower the wind load the multi-antenna arrangement is exposed to. Hence, if heavy wind is expected, a service technician may climb the mast to a multi-antenna mounting arrangement according to the present disclosure and by means of the adjustment arrangement, and the position marking arrangement, and by changing applied precoding in accordance thereto, configure the multi-antenna mounting arrangement to be less sensitive to wind.

FIG. 4 discloses a second exemplary embodiment of an adjustment arrangement 400b according to the disclosure. According to the second exemplary embodiment the adjustment arrangement 400b comprises a slidebar carrier 500d and a slidebar 500c, the slidebar carrier 500d being arranged to receive the slidebar 500c such that the slidebar 500c can move within the slidebar carrier 500d, and wherein one antenna arrangement 300c is arranged to the slidebar 500c and one antenna arrangement 300d is arranged to the slidebar carrier 300d.

As shown in FIG. 4, antenna arrangement 300c is arranged to the slidebar 500c and antenna arrangement 300d is arranged to slidebar carrier 500d. By moving the slidebar 500c within the slidebar carrier 500d the spatial separation between the antenna arrangements 300c, 300d can be changed.

For clarification, the slidebar 500c and the slidebar carrier 500d are examples of what herein also is referred to as (moveable) elements of an adjustment arrangement for the exemplary embodiment shown in FIG. 4.

According to embodiments, movements of the slidebar 500c and slidebar carrier 500d may for example be accomplished by means of a cogwheel arrangement 450 involving one or more revolving cogwheels 460, and/or pinion(s), engaging with for example apertures 470 of the slidebar 500c and slidebar carrier 500d respectively. The skilled person will recognize that instead of apertures, the cogwheel(s)/pinion(s) may instead engage with for example a rack with teeth arranged to the slidebar and/or slidebar carrier. For the sake of completeness, in FIG. 4, one very simplified, exemplary and not limiting embodiment of how such a cogwheel arrangement 450 may be provided is shown. The skilled person will recognize that also other cogwheel arrangements may provide the same functionality. As discussed herein, it is however preferred that the adjustment arrangement 400b is configured such that when the adjustment arrangement 400b is used to change the spatial separation d between the two antenna arrangements 300c, 300d, respective antenna arrangement 300c, 300d is moved an equal distance Δd/2 in respect to a reference point on an axis Axis B extending between, and through, the antenna arrangements 300c, 300d.

The cogwheel arrangement 450 may be arranged inside a housing (not shown in FIG. 4) enabling the adjustment arrangement 400b of the multi-antenna mounting arrangement to be arranged to for example an antenna mast (not shown in FIG. 4).

According to embodiments, also the movements of the of the slidebar 500c and the slidebar carrier 500d may be controlled my means of a crank handle (not shown in FIG. 4) and/or a motor (not shown in FIG. 4), where the crank handle or motor is arranged to control the displacement of the slidebar 500c within the slidebar carrier 500d. This may be achieved by controlling the cogwheel arrangement by means of the crank handle or motor.

Even though not shown in FIG. 4, also the adjustment arrangement 400b of FIG. 4 may be provided with a position marking arrangement.

FIG. 5 schematically discloses the physics of an exemplary multi-antenna system 1100 with two transmitting antennas 600a, 600b of a transmitting antenna arrangement 300c and two receiving antennas 600c, 600d of a receiving antenna arrangement 300d. Hence, FIG. 5 schematically illustrates a 2×2 MIMO antenna system.

In relation to FIG. 5, the following variables are used:
d₁=spatial separation between transmitting antennas, Tx
d₂=spatial separation between receiving antennas, Rx
D=direct path length/hop length
Δ_{D}=cross path length difference
Δ_{φ}=phase difference between antenna cross-channels and antenna direct channels
λ=wavelength
f=frequency

The relationship between wavelength, λ, and frequency, f, for microwaves is given by equation (1):

$$λ = c / f \qquad ( 1 )$$

where c is approximately 299 792 458 m/s (speed of light in air) if the medium of propagation of the microwaves is air.

The schematically illustrated multi-antenna system 1100 of FIG. 5 has two spatially separated transmitting antennas, Tx, 600a, 600b, separated by a distance d₁, and two spatially separated receiving antennas, Rx, 600c, 600d, separated by a distance d₂. The transmitting antennas 600a, 600b and the receiving antennas 600c, 600d are located a distance D away from each other. Herein, this distance is referred to as direct path length or hop length. Each transmitting antenna 600a, 600b is transmitting a microwave transmission, here generally referred to as data stream 900a, 900b, that is received by both receiving antennas 600c, 600d. Since respective receiving antenna 600c, 600d receives two data streams 900a, 900b, these data streams 900a, 900b may interfere with each other. However, the fundamental physics of a multi-antenna systems, such as MIMO antenna systems, allows the antennas 600a, 600b, 600c, 600d to be deployed, in terms of spatial separations d₁ and d₂, in such a way that there is an optimal phase difference, Δ_{φ}=90°, between the antenna cross-channels relative to the antenna direct channels. Thereby, the interfering data stream (900a or 900b) can be separated from the data stream of interest (900b or 900a) at respective receiving antenna 600c; 600d, whereby the two data streams 900a, 900b can be restored more or less perfectly and without any significant performance losses, at respective receiving antenna 600c, 600d.

For a given deployment in respect to direct path length, D, and wavelength/frequency, λ/f, there are many transmitting and receiving antenna spatial separations, d₁, d₂, that give Δ_{φ}=90° degrees, but the optimal configuration is defined as the smallest separation.

If Δ_{φ}=90°, the optimal transmitting and receiving antenna spatial separations, d₁, d₂, for a 2×2 or 4×4 MIMO antenna system, when d₁=d₂, is given by equation (2):

$${d}_{1} * {d}_{2} = D λ / 2 \qquad ( 2 )$$

This gives that if d₁=d₂=dₒₚₜ, where dₒₚₜ=the optimal spatial separation. dₒₚₜ is given by equation (3):

$${D}_{opt} = \sqrt{\frac{D λ}{2}} \qquad ( 3 )$$

A preferred embodiment of the present disclosure refers to an antenna mast arrangement comprising a multi-antenna mounting arrangement and an antenna mast. The multi-antenna mounting arrangement comprises two spatially separated antenna arrangements, the multi-antenna mounting arrangement being arranged to the antenna mast so that when the spatial separation d between the two antenna arrangements is changed, respective antenna arrangement is moved an equal distance Δd/2 in respect to a reference point on an axis extending between the antenna arrangements.

The terminology used herein is for describing aspects of the disclosure only. The embodiments herein are not limited to the above-described embodiments. Various alternatives, modifications and equivalents may be used. Therefore, the above embodiments should not be taken as limiting the scope of the embodiments, which is defined by the appending claims. A feature from one embodiment may be combined with one or more features of any other embodiment. It should be emphasized that the term “comprises/comprising” when used in this specification is taken to specify the presence of stated features, steps, devices, apparatuses or components, but does not preclude the presence or addition of one or more other features, steps, devices, apparatuses, components or groups thereof. It should also be noted that the words “a” or “an” preceding an element do not exclude the presence of a plurality of such elements. The term “configured to” used herein may also be referred to as “arranged to”, “adapted to”, “capable of” or “operative to”. In embodiments described herein, the joining terms, “connected to” or “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication. In some embodiments described herein, the term “coupled,” “connected,” and the like, may be used herein to indicate a connection, although not necessarily directly, and may include wired and/or wireless connections.

1. A multi-antenna mounting arrangement for configuring the spacing between two spatially separated antenna arrangements, the multi-antenna mounting arrangement comprising:
the two antenna arrangements and a controllable adjustment arrangement to which the antenna arrangements are arranged;
respective antenna arrangement comprising an antenna and a radio unit, the radio unit being collocated with, and connected to, the antenna; and
the adjustment arrangement enabling controlling the spatial separation (d) between the two antenna arrangements.

2. The multi-antenna mounting arrangement according to claim 1, wherein the antenna arrangements are spatially separated horizontally or vertically.

3. The multi-antenna mounting arrangement according to claim 1, wherein the adjustment arrangement is configured such that when using the adjustment arrangement to change the spatial separation (d) between the two antenna arrangements, a respective antenna arrangement is moved an equal distance (Δd/2) in respect to a reference point on an axis extending between the antenna arrangements.

4. The multi-antenna mounting arrangement according to claim 1, wherein the adjustment arrangement is provided with a position marking arrangement, the position marking arrangement indicating a position of at least one antenna arrangement.

5. The multi-antenna mounting arrangement according to claim 4, wherein the position marking arrangement indicates a service position and an operation position of one antenna arrangement.

6. The multi-antenna mounting arrangement according to claim 4, wherein the position marking arrangement indicates a second operation position of one antenna arrangement, wherein the second operation position is determined by applied precoding.

7. The multi-antenna mounting arrangement according to claim 1, wherein the adjustment arrangement comprises two, interconnected and in respect to each other moveable elements, wherein the antenna arrangements are arranged to one element each.

8. The multi-antenna mounting arrangement according claim 1, wherein the adjustment arrangement comprises:
a slidebar carrier and a slidebar, the slidebar carrier being arranged to receive the slidebar such that the slidebar can move within the slidebar carrier, and wherein one antenna arrangement is arranged to the slidebar and one antenna arrangement is arranged to the slidebar carrier.

9. The multi-antenna mounting arrangement according to claim 1, wherein the adjustment arrangement comprises:
two racks and a pinion, the two racks being arranged in parallel, and the pinion being arranged to separate the racks and to engage with the racks so that upon revolving of the pinion the racks move in opposite directions, and wherein one antenna arrangement is arranged to each of the racks.

10. The multi-antenna mounting arrangement according to claim 9, wherein the revolving of the pinion is controlled by turning a crank handle.

11. The multi-antenna mounting arrangement according to claim 1, wherein the adjustment arrangement comprises a motor arranged to control the operation of the adjustment arrangement.

12. The multi-antenna mounting arrangement according to claim 11, wherein the motor is configured to, upon a first trigger, control the adjustment arrangement so that one antenna arrangement is moved to a service position, and upon a second trigger, control the adjustment arrangement so that the one antenna arrangement is returned to the position it had before the first trigger occurred.

13. The multi-antenna mounting arrangement according to claim 11, wherein the motor is configured to, upon a third trigger, control the adjustment arrangement so that one antenna arrangement is displaced to a second operation position, wherein the second operation condition is determined by applied precoding.

14. The multi-antenna mounting arrangement according to claim 11, wherein the adjustment arrangement comprises:
two racks and a pinion, the two racks being arranged in parallel, and the pinion being arranged to separate the racks and to engage with the racks so that upon revolving of the pinion the racks move in opposite directions, and wherein one antenna arrangement is arranged to each of the racks, wherein the motor is arranged to control the revolving of the pinion.

15. The multi-antenna mounting arrangement according to claim 11, wherein the adjustment arrangement comprises a slidebar carrier and a slidebar, the slidebar carrier being arranged to receive the slidebar such that the slidebar can move within the slidebar carrier, and wherein one antenna arrangement is arranged to the slidebar and one antenna arrangement is arranged to the slidebar carrier, wherein the motor is arranged to control the displacement of the slidebar within the slidebar carrier.

16. A multi-antenna mast arrangement comprising:
an antenna mast and a multi-antenna mounting arrangement;
the multi-antenna mounting arrangement comprising two antenna arrangements and a controllable adjustment arrangement to which the antenna arrangements are arranged;
respective antenna arrangement comprising an antenna and a radio unit, the radio unit being collocated with, and connected to, respective antenna; and
the adjustment arrangement enabling controlling the spatial separation (d) between the two antenna arrangements.

17. The multi-antenna mast arrangement according to claim 16, wherein the adjustment arrangement is configured such that when using the adjustment arrangement to change the spatial separation (d) between the two antenna arrangements, a respective antenna arrangement is moved an equal distance (Δd/2) in respect to a reference point on an axis extending between the antenna arrangements.

18. The multi-antenna mast arrangement according to claim 16, wherein the adjustment arrangement is provided with a position marking arrangement, the position marking arrangement indicating a position of at least one antenna arrangement.

19. The multi-antenna mast arrangement according to claim 16, wherein the position marking arrangement indicates a service position and an operation position of one antenna arrangement.

20. The multi-antenna mast arrangement according to claim 19, wherein the position marking arrangement indicates a second operation position of one antenna arrangement, wherein the second operation position is determined by applied precoding.
